(19) United States
(12) Patent Application Publication
(10) Pub. No.: US 2011/0298926 A1
(43) Pub. Date: Dec. 8, 2011

(54) PARKING ASSISTANCE APPARATUS AND PARKING ASSISTANCE METHOD

(75) Inventors: Hiroshi Katsunaga, Aichi (JP); Kazunori Shimazaki, Aichi (JP); Tomio Kimura, Aichi (JP); Yutaka Nakashima, Aichi (JP); Koji Hika, Aichi (JP); Keisuke Inoue, Aichi (JP)

(73) Assignee: Kabushiki Kaisha Toyota Jidoshokki, Aichi (JP)

(21) Appl. No.: 13/202,004

(22) PCT Filed: Feb. 25, 2010
(86) PCT No.: PCT/JP2010/052950

§ 371 Date: Aug. 17, 2011

(30) Foreign Application Priority Data
Mar. 6, 2009 (JP) 2009-053609

(51) Int. Cl. H04N 7/18

(52) U.S. Cl. 348/148; 348/E07.085

(57) ABSTRACT

Provided is a parking assistance apparatus utilizing a fixed target by taking an image thereof, the parking assistance apparatus being capable of recognizing the fixed target with high recognition accuracy while using simple image recognition processing. A mark (M) includes a plurality of illuminators (1). Sets of the plurality of illuminators (1) form characteristic points C1 to C4. Turn-ON request generation means (36) of a vehicle-side device (20) sequentially generates turn-ON requests for each characteristic point and transmits the generated turn-ON requests to a parking-lot-side device (10). A display control unit (11) of the parking-lot-side device (10) turns ON the characteristic points based on the turn-ON requests. An image recognition unit (31) of the vehicle-side device (20) performs image recognition for the characteristic points sequentially. Using the recognition result, positional parameter calculation means (34) of the vehicle-side device (20) calculates positional parameters of a camera with respect to the mark (M).

### TECHNICAL FIELD

The present invention relates to a parking assistance apparatus which utilizes a fixed target by taking its image, and more particularly, to a parking assistance apparatus and a parking assistance method for more reliable recognition of the fixed target in the taken image.

### BACKGROUND ART

There has conventionally been known a parking assistance apparatus wherein a mark serving as a target is fixed in a parking lot or the like in advance and used in parking assistance. For example, in Patent Document 1, parking assistance is performed by taking an image of the mark by a camera, performing image recognition processing on the obtained image to identify coordinates of the mark, using the coordinates to determine a relative positional relationship between a vehicle and a target parking position, calculating a parking locus based on the relative positional relationship, and superimposing the parking locus on the taken image for display.

Patent Document 1 also discloses using illuminators such as light-emitting diodes (LEDs) as the mark. The mark using the illuminators has the advantages of being more stain-resistant and less susceptible to shape impairment due to rubbing as compared to such marks as paint or a sheet.

### RELATED ART

### Patent Document

Patent Document 1: WO 2008/081655 A1

### SUMMARY OF INVENTION

### Problems to be Solved by the Invention

However, an apparatus that takes an image of a mark and performs image recognition processing as in Patent Document 1 has problems in that image recognition processing is complex and in that there is a room for improvement in image recognition accuracy.

For example, if a mark consists only of a simple shape such as a square, it is impossible to discriminate the direction of the mark, which makes it difficult to determine the position of the vehicle. In other words, the mark needs to have a complex shape that allows the direction of the mark to be defined, which complicates the image recognition processing.

Further, the appearance of the mark from a camera is not fixed but varies depending on the presence of an occluding object, type of vehicle, structure of vehicle body, position where the camera is mounted, and distance, positional relationship and the like between the vehicle and the mark. Therefore, it is not always possible to take an image of the entire mark accurately, so there is room for improvement in image recognition accuracy for the mark.

The present invention has been made in order to solve the above-mentioned problems, and therefore has an object of providing a parking assistance apparatus and a parking assistance method capable of recognizing a fixed target at high recognition accuracy with simple image recognition processing.

### Means for Solving the Problems

According to the present invention, there is provided a parking assistance apparatus for assisting parking at a predetermined target parking position, comprising: a vehicle-side device mounted on a vehicle; and a parking-lot-side device provided in association with the predetermined target parking position, the parking-lot-side device comprising: a fixed target comprising a plurality of light-emitting means, the fixed target being fixed in a predetermined positional relationship with respect to the predetermined target parking position, each of the plurality of light-emitting means being provided in a predetermined positional relationship with respect to the fixed target; parking-lot-side communication means, which receives a turn-ON request transmitted from the vehicle-side device, the turn-ON request containing information regarding which of the plurality of light-emitting means is to be turned ON; and display control means for turning ON or OFF the plurality of light-emitting means based on the turn-ON request, the vehicle-side device comprising: turn-ON request generation means for generating the turn-ON request; vehicle-side communication means for transmitting the turn-ON request to the parking-lot-side device; a camera for taking an image of at least one of the plurality of light-emitting means; image recognition means for extracting characteristic points based on the image the at least one of the plurality of light-emitting means taken by the camera and recognizing two-dimensional coordinates of the characteristic points in the taken image; positional parameter calculation means for calculating positional parameters of the camera including at least a two-dimensional coordinate and a pan angle with respect to the fixed target, based on two or more two-dimensional coordinates recognized by the image recognition means and on the turn-ON request; relative position identification means for identifying relative positional relationship between the vehicle and the predetermined target parking position based on the positional parameters of the camera calculated by the positional parameter calculation means and the predetermined positional relationship of the fixed target with respect to the predetermined target parking position; and parking locus calculation means for calculating a parking locus for guiding the vehicle to the target parking position based on the relative positional relationship identified by the relative position identification means.

In accordance with the turn-ON request from the vehicle-side device, the parking-lot-side device turns ON particular light-emitting means. The image of the turned-ON light-emitting means is taken by the camera of the vehicle-side device, image recognition is performed, and the position of the camera and the position of the vehicle are identified based on the recognition result and the content of the turn-ON request. Based on the identified result of the vehicle, the vehicle is guided to the target parking position.

The turn-ON request generation means may generate a plurality of different turn-ON requests sequentially. With this construction, only one characteristic point is turned ON at one time point, so it can be avoided that a plurality of characteristic points which are turned ON simultaneously are mistaken for each other.

If the image recognition means has not recognized the two-dimensional coordinates of a predetermined number of the characteristic points, the turn-ON request generation means may generate anew turn-ON request. With this construction, processing can be repeated until a sufficient number of the characteristic points are recognized for calculating the positional parameters of the camera or until a sufficient number of the characteristic points are recognized for improving calculation accuracy enough.

The turn-ON request may include a first turn-ON request for turning ON characteristic points of a first size and a second turn-ON request for turning ON characteristic points of a second size, the second size may be smaller than the first size, the number of the characteristic points corresponding to the second turn-ON requests may be larger than the number of the characteristic points corresponding to the first turn-ON requests, and the turn-ON request generation means may generate one of the first turn-ON request and the second turn-ON request depending on the positional parameters or on the relative positional relationship. With this construction, an appropriate number of the characteristic points of appropriate size can be turned ON depending on the position of the vehicle.

One turn-ON request may correspond to one characteristic point.

The fixed target may include a plurality of fixed target portions, each of the plurality of fixed target portions may include a plurality of light-emitting means, one turn-ON request may correspond to a plurality of the characteristic points to be turned ON simultaneously in any one of the plurality of fixed target portions, and the turn-ON request generation means may generate different turn-ON requests depending on the positional parameters or on the relative positional relationship. With this construction, an appropriate fixed target portion may be turned ON depending on the position of the vehicle.

The characteristic points may be circular, and the two-dimensional coordinates of the characteristic points may be two-dimensional coordinates of centers of circles formed by respective characteristic point. With this construction, image recognition processing is simplified.

According to the present invention, there is also provided a parking assistance method using a vehicle-side device mounted on a vehicle and a parking-lot-side device provided in association with a predetermined target parking position, comprising the steps of: transmitting a turn-ON request from the vehicle-side device to the parking-lot-side device; turning ON or OFF a plurality of light-emitting means based on the turn-ON request; taking an image of at least one of the plurality of light-emitting means; extracting characteristic points of a fixed target based on the image taken of the light-emitting means and recognizing two-dimensional coordinates of the characteristic points in the taken image; calculating positional parameters of a camera including at least a two-dimensional coordinate and a pan angle with respect to the fixed target, based on two or more recognized two-dimensional coordinates and the turn-ON request; identifying a relative positional relationship between the vehicle and the target parking position based on the calculated positional parameters of the camera and the predetermined positional relationship of the fixed target with respect to the target parking position; and calculating a parking locus for guiding the vehicle to the target parking position based on the identified relative positional relationship.

### Effect of the Invention

According to the parking assistance apparatus and the parking assistance method of the present invention, the characteristic points are turned ON in accordance with the turn-ON request, so the fixed target can be recognized at high recognition accuracy while using simple image recognition processing.

### BRIEF DESCRIPTION OF THE DRAWINGS

FIG. 1 is a diagram schematically illustrating the construction of a parking assistance apparatus according to a first embodiment.

FIG. 2 is a block diagram illustrating the construction of the parking assistance apparatus according to the first embodiment.

FIG. 3 is a diagram illustrating a construction of a parking assistance computing unit according to the first embodiment.

FIG. 4 is a diagram illustrating a construction of a mark according to the first embodiment.

FIG. 5 illustrates a state in which illuminators of the mark display four characteristic points.

FIG. 6 is a flow chart illustrating a schematic operation of the parking assistance apparatus according to the first embodiment.

FIG. 7 shows schematic diagrams illustrating a schematic operation of the parking assistance apparatus according to the first embodiment.

FIG. 8 is a flow chart illustrating details of the parking assistance operation of FIG. 6.

FIG. 9 is a schematic diagram illustrating details of the parking assistance operation of FIG. 6.

FIG. 10 is a flow chart illustrating a parking assistance operation according to a second embodiment.

FIG. 11 is a diagram illustrating a state in which illuminators of a mark display nine characteristic points according to a third embodiment.

FIG. 12 is a flow chart illustrating a parking assistance operation according to the third embodiment.

FIG. 13 shows schematic diagrams illustrating the parking assistance operation according to the third embodiment.

FIG. 14 is a diagram illustrating a construction of a first mark according to a fourth embodiment.

FIG. 15 is a flow chart illustrating a parking assistance operation according to the fourth embodiment.

FIG. 16 shows schematic diagrams illustrating the parking assistance operation according to the fourth embodiment.

FIG. 17 is a diagram illustrating a construction in which a mark similar to those used in the first to third embodiments is used in the fourth embodiment.

FIG. 18 shows schematic diagrams illustrating a parking assistance operation according to a fifth embodiment.

FIG. 19 shows schematic diagrams illustrating a parking assistance operation according to a sixth embodiment.

FIG. 20 is a diagram illustrating a mark coordinate system used for calculating positional parameters.

FIG. 21 is a diagram illustrating an image coordinate system used for calculating the positional parameters.

### DESCRIPTION OF EMBODIMENTS

### First Embodiment

Hereinafter, a first embodiment of the present invention is described with reference to the accompanying drawings.

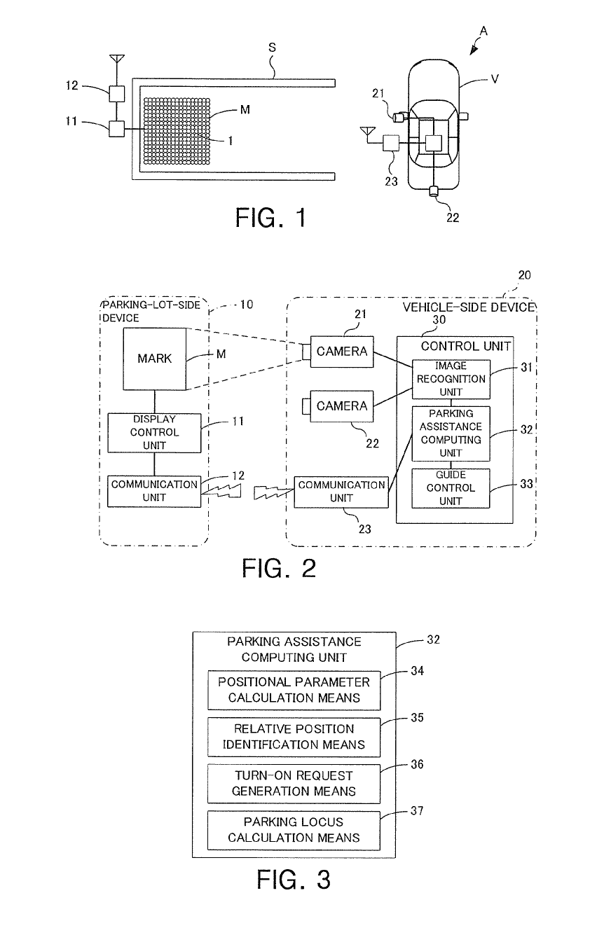

FIGS. 1 and 2 are diagrams schematically illustrating a construction of a parking assistance apparatus according to the first embodiment of the present invention. A parking space S is a predetermined target parking position at which a driver of a vehicle V intends to park the vehicle V. The parking assistance apparatus according to the present invention assists the driver in the parking.

A parking-lot-side device 10 is provided in association with the parking space S, and a vehicle-side device 20 is mounted on the vehicle V.

The parking-lot-side device 10 includes a mark M serving as a fixed target. The mark M has a shape of a so-called electronic bulletin board including a plurality of illuminators 1 (plurality of light-emitting means). The illuminators 1 may be, for example, light emitting diodes (LEDs). The mark M is fixed to a predetermined place having a predetermined positional relationship with respect to the parking space S, for example, on a floor surface. The predetermined positional relationship of the mark M with respect to the parking space S is known in advance, and the predetermined positional relationship of each illuminator 1 with respect to the mark M is also known in advance. Therefore, the positional relationship of each illuminator 1 with respect to the parking space S is also known in advance.

The parking-lot-side device 10 includes a display control unit (display control means) 11 for controlling the illuminators 1 of the mark M. The display control unit 11 performs control to turn each of the illuminators 1 ON or OFF independently. The parking-lot-side device 10 also includes a parking-lot-side communication unit (parking-lot-side communication means) 12 for communicating with the vehicle-side device 20.

The vehicle-side device 20 includes a camera 21 and a camera 22 for taking an image of at least one of the illuminators 1 of the mark M, a vehicle-side communication unit (vehicle-side communication means) 23 for communicating with the parking-lot-side device 10, and a control unit 30 connected to the camera 21, the camera 22, and the vehicle-side communication unit 23, for controlling an operation of the vehicle-side device 20.

The camera 21 and the camera 22 are mounted at respective predetermined positions having respective predetermined positional relationships with respect to the vehicle V. For example, the camera 21 is built in a door mirror of the vehicle V and is arranged so that the mark M provided on the floor surface of the parking space S is included in the field of view if the vehicle V is at a location A in the vicinity of the parking space S. Similarly, the camera 22 is mounted rearward at a rear portion of the vehicle V and is arranged so that the mark M is included in the field of view if the positional relationship between the vehicle V and the mark M corresponds to a predetermined relationship different from FIG. 1.

Further, the vehicle-side communication unit 23 is capable of mutual communication with the above-mentioned parking-lot-side communication unit 12. The communication may be performed by any non-contact method, for example, using a radio signal or an optical signal.

The control unit 30 includes an image recognition unit (image recognition means) 31 connected to the camera 21 and the camera 22, for extracting characteristic points from the taken image and recognizing two-dimensional coordinates of the characteristic points in the image. The control unit 30 also includes a guide control unit (guide control means) 33 for calculating a parking locus for guiding the vehicle into the parking space and outputting guide information for a drive operation based on the parking locus to the driver of the vehicle by means of video, sound, or the like. The control unit 30 further includes a parking assistance computing unit 32 for controlling the image recognition unit 31, the vehicle-side communication unit 23 and the guide control unit 33.

FIG. 3 illustrates a construction of the parking assistance computing unit 32. The parking assistance computing unit includes positional parameter calculation means 34 for calculating positional parameters of the camera 21 or the camera 22 with respect to the characteristic points. The parking assistance computing unit 32 also includes relative position identification means 35 for identifying relative positional relationship between the vehicle and the parking space, turn-ON request generation means 36 for generating information as to which of the illuminators 1 of the mark M is to be turned ON, and parking locus calculation means 37 for calculating the parking locus for guiding the vehicle V to the target parking position based on the relative positional relationship identified by the relative position identification means 35.

The positional parameter calculation means 34 stores the predetermined positional relationship of the mark M with respect to the parking space S, and the predetermined positional relationship of each illuminator 1 with respect to the mark M. Alternatively, the positional parameter calculation means 34 stores the positional relationship of each illuminator 1 with respect to the parking space S.

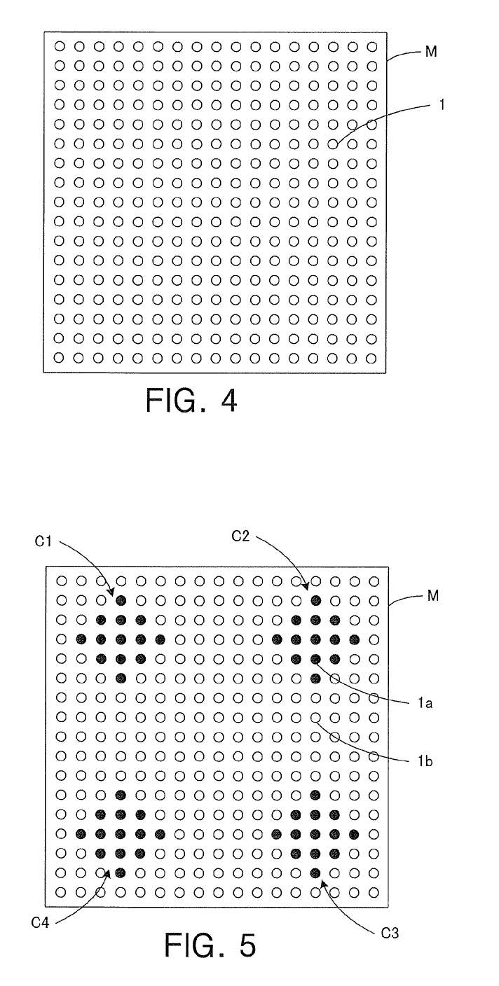

FIG. 4 illustrates a construction of the mark M located and fixed in the parking space S. The plurality of illuminators 1 are fixedly arranged in a predetermined region of the mark M. By turning ON predetermined illuminators 1, an arbitrary shape may be displayed.

FIG. 5 illustrates a state in which the illuminators 1 of the mark M display four characteristic points C1 to C4. FIG. 5 illustrates the state in which illuminators 1a constituting a part of the illuminators 1 are turned ON and emit light (illustrated as solid black circles), and the other illuminators 1b are not turned ON and do not emit light (illustrated as outlined white circles). A set of neighboring turned-ON illuminators 1a forms each of the characteristic points C1 to C4. Here, in FIG. 5, although each of the characteristic points C1 to C4 are actually not points but substantially circular regions having an area, only one position need be determined for each of the characteristic points (that is, a two-dimensional coordinate corresponding to each of the characteristic points). For example, the two-dimensional coordinate corresponding to the characteristic point C1 may be the two-dimensional coordinate of the center of a circle formed by the characteristic point C1, regarding the region occupied by the characteristic point C1 as the circle. The same holds true for the characteristic points C2 to C4.

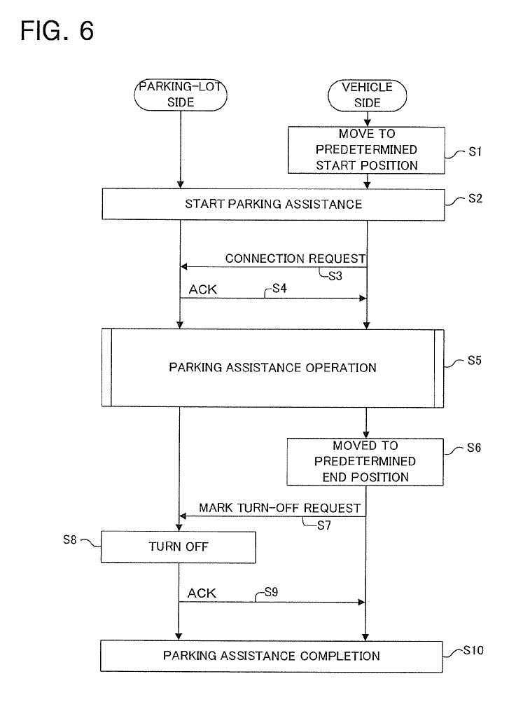

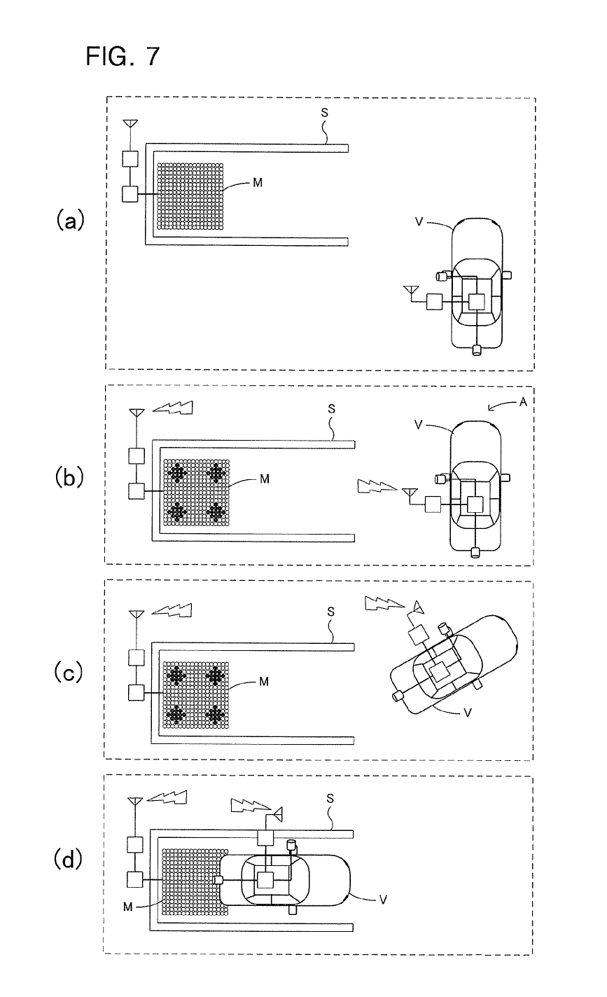

Next, referring to the flow chart of FIG. 6 and schematic diagrams of FIG. 7, a flow of an operation of the parking assistance apparatus in the first embodiment is outlined.

FIG. 7(a) illustrates a state before parking assistance is started. The vehicle V has not reached a predetermined start position, and all the illuminators 1 of the mark M are OFF.

The driver operates the vehicle V so as to be positioned at a predetermined parking assistance start position in the vicinity of the parking space S (Step S1). The predetermined position is, for example, the location A illustrated in FIG. 7(b). Next, the driver instructs the parking assistance apparatus to start a parking assistance operation (Step S2). The instruction is given, for example, by turning ON a predetermined switch.

Upon receiving the instruction, the vehicle-side device 20 transmits a connection request to the parking-lot-side device 10 via the vehicle-side communication unit 23 (Step S3). The connection request is received by the display control unit 11 via the parking-lot-side communication unit 12. Upon receiving the connection request, the display control unit 11 transmits an acknowledgement (ACK) indicating normal reception to the vehicle-side device 20 via the parking-lot-side communication unit 12 (Step S4), and the acknowledgement is received by the parking assistance computing unit 32 via the vehicle-side communication unit 23.

As described above, any communication between the parking-lot-side device 10 and the vehicle-side device 20 is performed via the parking-lot-side communication unit 12 and the vehicle-side communication unit 23. The same applies to the following description.

Thereafter, the parking assistance operation is performed (Step S5). The vehicle V travels in accordance with the drive operation of the driver, which changes the relative positional relationship between the vehicle V and each of the parking space S and the mark M. FIG. 7(c) illustrates this state.

If the vehicle V moves to a predetermined end position with respect to the parking space S (Step S6), the turn-ON request generation means 36 generates a mark turn-OFF request, which is information indicating that the entire mark M is (all the illuminators 1 are) to be turned OFF, and transmits the generated mark turn-OFF request to the parking-lot-side device 10 (Step S7). Based on the mark turn-OFF request, the display control unit 11 turns OFF all the illuminators 1 of the mark M (Step S8). FIG. 7(d) illustrates this state. Thereafter, the display control unit 11 transmits an acknowledgement as a turned-OFF notification indicating that all the illuminators 1 of the mark M are OFF (Step S9). This completes the operation of the parking assistance apparatus (Step S10).

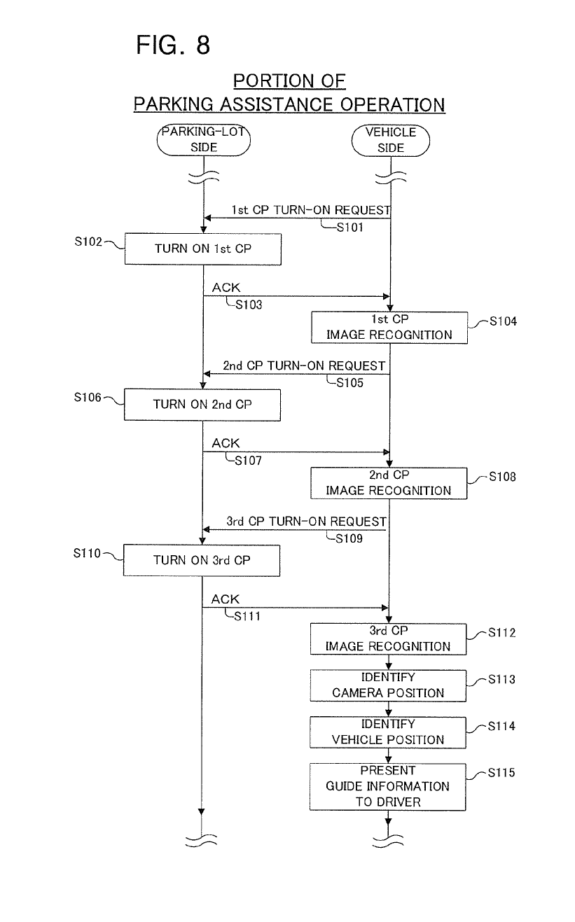

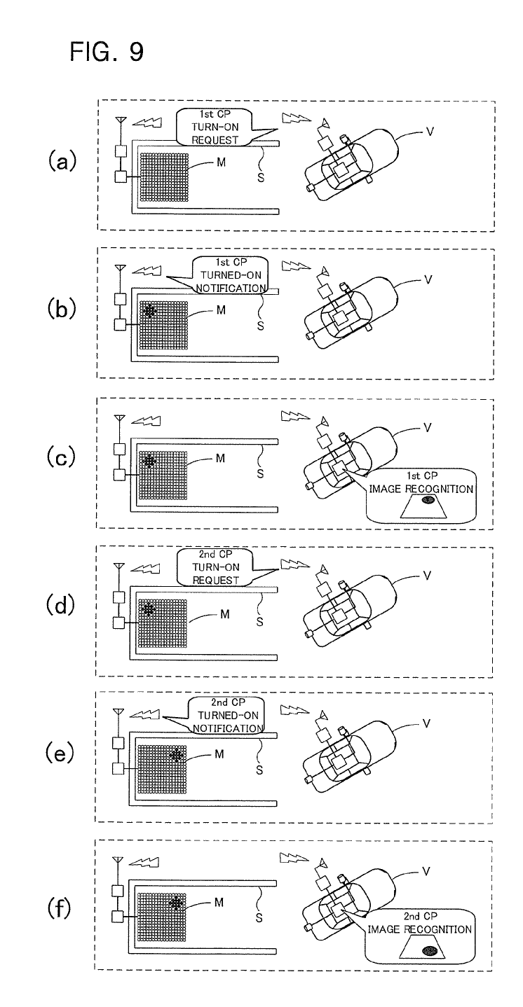

Next, referring to the flow chart of FIG. 8 and schematic diagrams of FIG. 9, the parking assistance operation in Step S5 of FIG. 6 is described in more detail. FIG. 8 illustrates a part of the detailed operation included in Step S5, and FIG. 9 illustrates states of the mark M at respective time points of FIG. 8.

In the processing of FIG. 8, the turn-ON request generation means 36 first generates a turn-ON request, which is information indicating that a first characteristic point is to be turned ON, and transmits the generated turn-ON request to the parking-lot-side device 10 (Step S101). Here, the first characteristic point is the characteristic point C1. FIG. 9(a) is a schematic diagram at this time point.

The turn-ON request may be in any form. For example, the turn-ON request may contain information for every illuminator 1 indicating whether the illuminator 1 is to be turned ON or OFF. Alternatively, the turn-ON request may contain information specifying only the illuminators 1 that are to be turned ON. Further, the turn-ON request may contain identification information representing the characteristic point C1, and in this case, the display control unit 11 may specify the illuminators 1 to be turned ON based on the identification information.

Next, the display control unit 11 turns ON illuminators 1 of the mark M that constitute the characteristic point C1 and turns OFF the others based on the turn-ON request for the first characteristic point (Step S102). Thereafter, the display control unit 11 transmits an acknowledgement as a turned-ON notification indicating that the characteristic point C1 is ON (Step S103). FIG. 9(b) is a schematic diagram of this time point.

If the parking assistance computing unit 32 receives the turned-ON notification indicating that the characteristic point C1 is ON, the image recognition unit 31 performs image recognition for the characteristic point C1 (Step S104). In Step S104, the image recognition unit 31 receives an image taken by the camera 21 or the camera 22 as an input, extracts the characteristic point C1 from the image, and recognizes and obtains the two-dimensional coordinate of the characteristic point C1 in the image. FIG. 9(c) is a schematic diagram at this time point.

Here, which of the images taken by the camera 21 and the camera 22 is to be used may be determined by various methods including well-known techniques. For example, the driver may specify any one of the cameras depending on the positional relationship between the vehicle V and the mark M, or the driver may specify any one of the cameras after checking respective images taken by the cameras. Alternatively, the coordinate of the characteristic point C1 may be obtained for both images and one of the images for which the coordinate is successfully obtained may be used. In the following, an image taken by the camera 21 is used as an example.

In addition, as described above in relation to FIG. 5, although the characteristic point C1 is a region having an area, the image recognition unit 31 identifies only one coordinate of the characteristic point C1. For example, the region occupied by the characteristic point C1 is regarded as a circle, and the center of the circle may correspond to the coordinate of the characteristic point C1.

Note that, in the example of FIG. 5, all the characteristic points C1 to C4 have the same shape, so it is not possible to discriminate which of the characteristic points is ON based on the shape. However, because the turn-ON request (Step S101) transmitted immediately before Step S104 or the acknowledgement (Step S103) received immediately before Step S104 is for the characteristic point C1, the parking assistance computing unit 32 recognizes the coordinate as that of the characteristic point C1.

Next, processing similar to Steps S101 to S104 is performed for a second characteristic point.

The turn-ON request generation means 36 generates a turn-ON request, which is information indicating that the second characteristic point is to be turned ON, and transmits the generated turn-ON request to the parking-lot-side device 10 (Step S105). Here, the second characteristic point is the characteristic point C2. FIG. 9(d) is a schematic diagram at this time point. In this manner, a plurality of different turn-ON requests are transmitted sequentially. Note that, at the time point of FIG. 9(d), the lighting state of the mark M is not changed, and the characteristic point C1 remains displayed.

Next, the display control unit 11 turns ON the illuminators 1 of the mark M that constitute the characteristic point C2 and turns OFF the others based on the turn-ON request for the second characteristic point (Step S106). Thereafter, the display control unit 11 transmits an acknowledgement as a turned-ON notification indicating that the characteristic point C2 is ON (Step S107). FIG. 9(e) is a schematic diagram at this time point.

Upon receiving the turned-ON notification indicating that the characteristic point C2 is ON, the parking assistance computing unit 32 controls the image recognition unit 31 to perform image recognition for the characteristic point C2 (Step S108). In Step S108, the image recognition unit 31 receives an image taken by the camera 21 as an input, extracts the characteristic point C2 from the image, and recognizes and obtains the two-dimensional coordinate of the characteristic point C2 in the image. FIG. 9(f) is a schematic diagram at this time point.

Note that, at this time point, the characteristic point C1 is already OFF and the mark M displays only the characteristic point C2 so that the image recognition unit 31 does not mistake a plurality of characteristic points for one another in the recognition. In other words, there is no need to give different shapes to the characteristic points or to provide an indication as a reference that indicates the direction of the mark M in order to distinguish the characteristic points from one another. Therefore, the recognition processing for the characteristic points by the image recognition unit 31 may be simplified, and high recognition accuracy may be obtained.

Next, processing similar to Steps S101 to S104 is performed for a third characteristic point.

The turn-ON request generation means 36 generates a turn-ON request, which is information indicating that the third characteristic point is to be turned ON, and transmits the generated turn-ON request to the parking-lot-side device 10 (Step S109). Here, the third characteristic point is the characteristic point C3.

Next, the display control unit 11 turns ON the illuminators 1 of the mark M that constitute the characteristic point C3 and turns OFF the others based on the turn-ON request for the third characteristic point (Step S110). Thereafter, the display control unit 11 transmits an acknowledgement as a turned-ON notification indicating that the characteristic point C3 is ON (Step S111).

Upon receiving the turned-ON notification indicating that the characteristic point C3 is ON, the parking assistance computing unit 32 controls the image recognition unit 31 to perform image recognition for the characteristic point C3 (Step S112). In Step S112, the image recognition unit 31 receives an image taken by the camera 21 as an input, extracts the characteristic point C3 from the image, and recognizes and obtains the two-dimensional coordinate of the characteristic point C3 in the image.

Note that, at this time point, the characteristic points C1 and C2 are already OFF and the mark M displays only the characteristic point C3. Thus, the image recognition unit 31 does not mistake a plurality of characteristic points for one another in the recognition.

Next, based on the two-dimensional coordinate of each of the characteristic points C1 to C3 recognized by the image recognition unit 31, the positional parameter calculation means 34 calculates positional parameters consisting of six parameters of a three-dimensional coordinate (x, y, z), a tilt angle (i.e. an inclination angle), a pan angle (i.e. a direction angle), and a swing angle (a rotation angle) of the camera 21 with respect to the mark M (Step S113).

Described next is a method of calculating the positional parameters by the positional parameter calculation means 34 in Step S113.

The positional parameters are calculated using a mark coordinate system and a camera coordinate system.

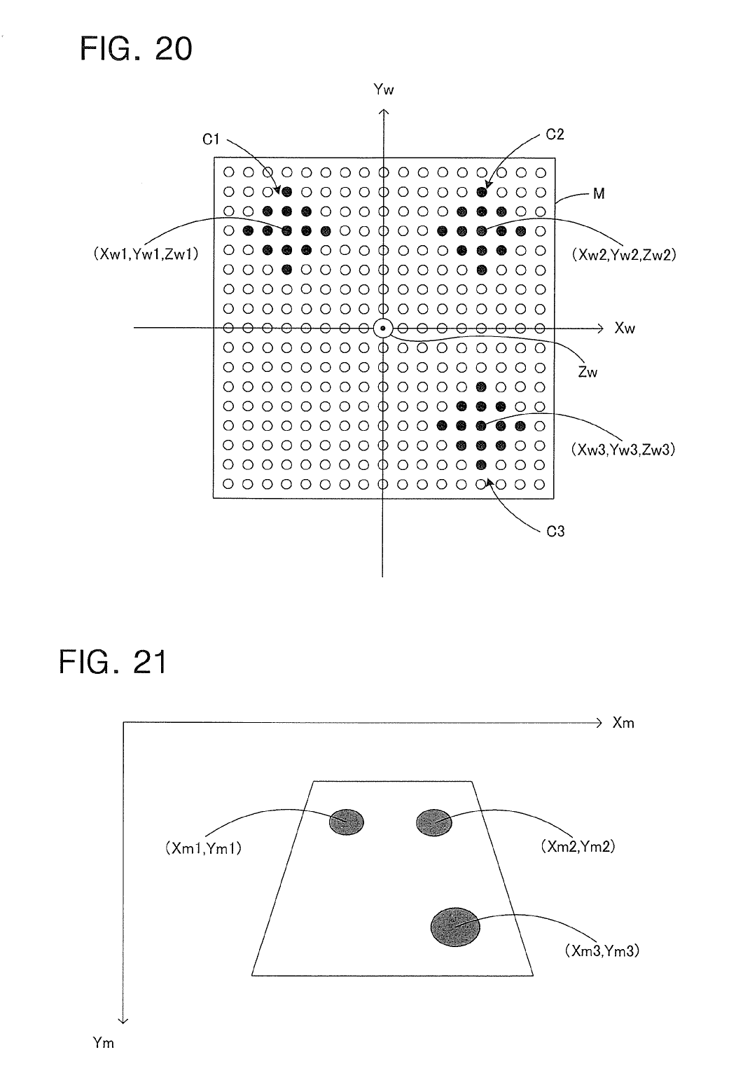

FIG. 20 is a diagram illustrating the mark coordinate system. The mark coordinate system is a three-dimensional world coordinate system representing the positional relationship between the mark M and the camera 21. In this coordinate system, as illustrated in FIG. 20, for example, an Xw axis, a Yw axis and a Zw axis may be set with the center of the mark M as the origin (Zw axis is an axis extending toward the front of the sheet). Coordinates of a characteristic point Cn (where 1≦n≦3) are expressed as (Xwn, Ywn, Zwn).

FIG. 21 is a diagram illustrating the camera coordinate system. The camera coordinate system is a two-dimensional image coordinate system representing the mark in the image taken by the camera 21. In this coordinate system, as illustrated in FIG. 21, for example, an Xm axis and a Ym axis may be set with the upper left corner of the image as the origin. Coordinates of the characteristic point Cn are expressed as (Xmn, Ymn).

The coordinate values (Xmn, Ymn) of the characteristic point Cn of the mark M in the image coordinate system may be expressed using predetermined functions F and G by Simultaneous Equations 1 below.

Xmn=F(Xwn,Ywn,Zwn,Ki,Lj)+DXn; and

Ymn=G(Xwn,Ywn,Zwn,Ki,Lj)+DYn Simultaneous Equations 1:

where:

Xwn, Ywn, and Zwn are coordinate values of the mark M in the world coordinate system, which are known;

Ki (1≦i≦6) are positional parameters to be determined of the camera 21, of which K1 represents an X coordinate, K2 represents a Y coordinate, K3 represents a Z coordinate, K4 represents the tilt angle, K5 represents the pan angle, and K6 represents the swing angle;

Lj (j≧1) are known camera internal parameters. For example, L1 represents a focal length, L2 represents a distortion coefficient, L3 represents a scale factor, and L4 represents a lens center; and

DXn and DYn are deviations between the X and Y coordinates of the characteristic point Cn, which are calculated using the functions F and G, and the X and Y coordinates of the characteristic point Cn, which are recognized by the image recognition unit 31. The values of the deviations should be all zero in a strict sense, but vary depending on the error in image recognition, the calculation accuracy, and the like.

Note that Simultaneous Equations 1 include six relational expressions in this example because 1≦n≦3.

By thus representing X and Y coordinates of the three characteristic points C1 to C3, respectively, a total of six relational expressions are generated for six positional parameters Ki (1≦i≦6), which are unknowns.

Therefore, the positional parameters Ki (1≦i≦6) that minimizes the square sum of the deviations:

S=Σ(DXn²+DYn²)

are determined. In other words, an optimization problem for minimizing S is solved. A known optimization method, such as a simplex method, a steepest descent method, a Newton method, a quasi-Newton method, or the like may be used.

In this manner, the relationship between the mark M on a road surface and the camera 21 is calculated as the positional parameters of the camera 21.

Note that, in this example, the same number of relational expressions as the number of positional parameters Ki to be calculated (here, “six”) are generated to determine the positional parameters. However, if a larger number of characteristic points are used, a larger number of relational expressions may be generated, thereby obtaining the positional parameters Ki more accurately. For example, ten relational expressions may be generated by using five characteristic points for six positional parameters Ki.

Using the thus-calculated positional parameters of the camera 21, the relative position identification means 35 identifies the relative positional relationship between the vehicle V and the parking space S (Step S114).

The identification of the relative positional relationship in Step S114 is performed as follows. First, the positional relationship of the mark M with respect to the vehicle V is identified based on the positional parameters calculated by the positional parameter calculation means 34 and the predetermined positional relationship of the camera 21 with respect to the vehicle V which is known in advance. Here, the positional relationship of the mark M with respect to the vehicle V may be expressed by using a three-dimensional vehicle coordinate system having a vehicle reference point fixed to the vehicle V as a reference.

For example, the position and the angle of the mark M in the vehicle coordinate system may be uniquely expressed by using a predetermined function H as follows:

Vi=H(Ki,Oi)

where Oi (1≦i≦6) are offset parameters between the vehicle reference point and a camera position in the vehicle coordinate system, which are known. Further, Vi (1≦i≦6) are parameters representing the position and the angle of the mark M in the vehicle coordinate system viewed from the vehicle reference point.

In this manner, the positional relationship of the vehicle V with respect to the mark M on the road surface is calculated.

Next, the relative positional relationship between the vehicle V and the parking space S is identified based on the predetermined positional relationship of the mark M with respect to the parking space S and the positional relationship of the vehicle V with respect to the mark M.

Next, the guide control unit 33 presents (Step S115), to the driver, guide information for guiding the vehicle V into the parking space S based on the relative positional relationship between the vehicle V and the parking space S, which is identified by the relative position identification means 35. Here, the parking locus calculation means 37 first calculates the parking locus for guiding the vehicle V to the target parking position based on the relative positional relationship identified by the relative position identification means 35, and then the guide control unit 33 provides guidance so that the vehicle V travels along the calculated parking locus. In this manner, the driver may cause the vehicle V to travel in accordance with the appropriate parking locus to be parked by performing drive operation merely in accordance with the guide information.

Steps S101 to S115 of FIG. 8 are repeatedly executed. The series of processing may be repeated at predetermined time intervals, may be repeated depending on the travel distance interval of the vehicle V, or may be repeated depending on the drive operation (start, stop, change in steering angle, etc.) by the driver. By repeating the processing, the vehicle may be accurately parked in the parking space S, which is the final target parking position, with almost no influence from errors in initial recognition for the characteristic points C1 to C3 of the mark M, states of the vehicle V such as tire wear and inclination of the vehicle V, condition of the road surface such as steps, tilt, or the like.

Further, as the distance between the vehicle V and the parking space S becomes smaller, mark M may be recognized larger in a closer distance. Therefore, the resolution of the characteristic points C1 to C3 of the mark M is improved, and distances among the characteristic points C1 to C3 become larger. Thus, the relative positional relationship between the mark M and the vehicle V may be identified at high accuracy, and the vehicle may be parked more accurately.

Note that, in a case where the processing of FIG. 8 is performed while the vehicle V is traveling, image recognition for different characteristic points may be performed at different positions of the vehicle V. In such case, correction may be made based on the locus during the traveling and the travel distance.

In addition, the relative positional relationship between each of the camera 21 and the camera 22 and the mark M changes as the vehicle V travels, so it is possible that the mark M or the characteristic points move out of the field of view of the cameras, or come into the field of view of the same camera again or into the field of view of another camera. In such cases, which of the images taken by the camera 21 or the camera 22 is to be used may be changed dynamically using various methods including well-known techniques. For example, the driver may switch the cameras depending on the positional relationship between the vehicle V and the mark M, or the driver may switch the cameras after checking respective images taken by the cameras. Alternatively, image recognition for the characteristic points may be performed for both images and one of the images in which more characteristic points are successfully recognized may be used.

Note that, the display control unit 11 of the parking-lot-side device 10, and the control unit 30, the image recognition unit 31, the parking assistance computing unit 32, the guide control unit 33, the positional parameter calculation means 34, the relative position identification means 35, the turn-ON request generation means 36, and the parking locus calculation means 37 of the vehicle-side device 20 may each be constituted of a computer. Therefore, if the operations of Steps S1 to S10 of FIG. 6 and Steps S101 to S115 of FIG. 8 are recorded as a parking assistance program in a recording medium or the like, each step may be executed by the computer.

Note that, in the above-mentioned first embodiment, the positional parameters consisting of six parameters including the three-dimensional coordinate (x, y, z), the tilt angle (inclination angle), the pan angle (direction angle), and the swing angle (rotation angle) of the camera 21 with respect to the mark M are calculated. Therefore, the relative positional relationship between the mark M and the vehicle V may be correctly identified to perform parking assistance at high accuracy even if there is a step or an inclination between the floor surface of the parking space S, on which the mark M is located, and the road surface at the current position of the vehicle V.

Note that, if there is no inclination between the floor surface of the parking space S, on which the mark M is located, and the road surface at the current position of the vehicle V, the relative positional relationship between the mark M and the vehicle V may be identified by calculating positional parameters consisting of at least four parameters including the three-dimensional coordinate (x, y, z) and the pan angle (direction angle) of the camera 21 with respect to the mark M. In this case, the four positional parameters may be determined by generating four relational expressions by using two-dimensional coordinates of at least two characteristic points of the mark M. Note that, if two-dimensional coordinates of a larger number of characteristic points are used, the accuracy may be improved by using a least square method or the like.

Further, in a case where the mark M and the vehicle V are on the same plane and there is no step or inclination between the floor surface of the parking space S on which the mark M is located and the road surface at the current position of the vehicle V, the relative positional relationship between the mark M and the vehicle V may be identified by calculating positional parameters consisting of at least three parameters including the two-dimensional coordinate (x, y) and the pan angle (direction angle) of the camera 21 with respect to the mark M. In this case also, the three positional parameters may be determined by generating four relational expressions by using the two-dimensional coordinates of at least two characteristic points of the mark M. However, if two-dimensional coordinates of a larger number of characteristic points are used, the three positional parameters may be calculated at high accuracy by using a least square method or the like.

In the above-mentioned first embodiment, the vehicle V comprises two cameras (camera 21 and camera 22). However, the vehicle V may comprise only one camera instead. Alternatively, the vehicle V may comprise three or more cameras and switch the cameras to be used for the image recognition appropriately as in the first embodiment.

In addition, if images of one characteristic point are taken by a plurality of cameras simultaneously, all the images including the characteristic point may be subjected to image recognition. For example, if two cameras take images of one characteristic point simultaneously, four relational expressions may be generated from one characteristic point. Therefore, if the mark M includes one characteristic point, the positional parameters consisting of four parameters including the three-dimensional coordinate (x, y, z) and the pan angle (direction angle) of the camera 21 can be calculated. If the mark M includes two characteristic points, the positional parameters consisting of six parameters including the three-dimensional coordinate (x, y, z), the tilt angle (inclination angle), the pan angle (direction angle), and the swing angle (rotation angle) of the camera 21 can be calculated.

Further, although the characteristic point is substantially circular in the first embodiment, the characteristic point may have another shape such as a cross or a square, and a different number of illuminators 1 may be used to form the characteristic point.

In addition, in the above-mentioned first embodiment, in Step S115, the guide control unit 33 presents the guide information to the driver in order to prompt a manual driving operation by the driver. As a modified example, in Step S115, automatic driving may be performed in order to guide the vehicle V to the target parking position. In this case, the vehicle V may include a well-known construction necessary to perform automatic driving and may travel automatically along the parking locus calculated by the parking locus calculation means 37.

Such construction may be realized by using, for example, a sensor for detecting a state relating to the travel of the vehicle V, a steering control unit for controlling steering angle, an acceleration control unit for controlling acceleration, and a deceleration control unit for controlling deceleration. Those units output travel signals such as an accelerator control signal for acceleration, a brake control signal for deceleration, and a steering control signal for steering the wheel in order to cause the vehicle V to travel automatically. Alternatively, a construction may be employed in which the wheel may be automatically steered in accordance with a movement of the vehicle V in response to the brake operation or the accelerator operation by the driver.

### Second Embodiment

In the first embodiment, as illustrated in FIG. 8, the image recognition is performed always on the fixed three characteristic points C1 to C3. In a second embodiment, the number of characteristic points to be subjected to the image recognition in the first embodiment is dynamically changed depending on the situation.

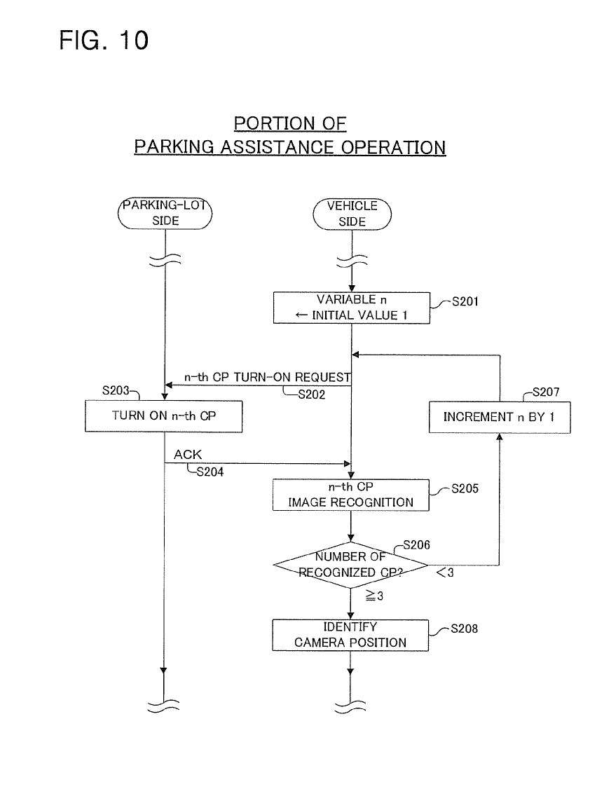

Referring to the flow chart of FIG. 10, an operation of a parking assistance apparatus in the second embodiment is described. Note that FIG. 10 illustrates a part of the detailed operation included in Step S5 of FIG. 6.

In the processing of FIG. 10, the turn-ON request generation means 36 first assigns 1 as an initial value to a variable n representing the number of the characteristic point (Step S201). Next, the turn-ON request generation means 36 generates a turn-ON request for the n-th characteristic point and transmits the generated turn-ON request to the parking-lot-side device 10 (Step S202). Here, the turn-ON request for the first characteristic point is generated and transmitted because n=1. The first characteristic point is, for example, the characteristic point C1.

Next, the display control unit 11 turns ON the illuminators 1 of the mark M that constitute the corresponding characteristic point and turns OFF the others based on the received turn-ON request (Step S203). Here, the turn-ON request for the characteristic point C1 has been received, so the display control unit 11 turns ON the characteristic point C1.

Thereafter, the display control unit 11 transmits an acknowledgement as a turned-ON notification indicating that the characteristic point corresponding to the turn-ON request is ON (Step S204).

If the parking assistance computing unit 32 receives the turned-ON notification indicating that the characteristic point corresponding to the turn-ON request is ON, the image recognition unit 31 performs image recognition for the n-th characteristic point (Step S205). Here, the image recognition for the characteristic point C1 is performed. In Step S205, the image recognition unit 31 receives an image taken by the camera 21 or the camera 22 as an input, extracts the characteristic point C1 from the image, and recognizes and obtains the two-dimensional coordinate of the characteristic point C1 in the image. Here, it is assumed that the image recognition for the characteristic point C1 succeeds and the two-dimensional coordinate can be obtained.

Here, the second embodiment assumes not only the case where the image recognition for the characteristic point is successful and the coordinates of the characteristic points can be obtained correctly, but also a case where the coordinate of the characteristic point cannot be obtained. Cases where the coordinate of the characteristic points cannot be obtained may possibly include, for example, a case where an image of the characteristic points is not taken or the image is taken but in a state that is not satisfactory for the image recognition due to the presence of an occluding object, the type of vehicle, the structure of vehicle body, the position where the camera is mounted, the distance and positional relationship between the vehicle and the mark, and the like.

Next, the image recognition unit 31 determines whether the number of characteristic points for which the image recognition has succeeded is 3 or more (Step S206). In this example, the number of characteristic points for which the image recognition has succeeded is 1 (i.e. only the characteristic point C1), that is, less than 3. In this case, the turn-ON request generation means 36 increments the value of the variable n by 1 (Step S207), and the processing returns to Step S202. That is, the processing in Steps S202 to S205 is performed for a second characteristic point (for example, characteristic point C2). Here, it is assumed that the image recognition for the characteristic point C2 succeeds.

Thereafter, the determination in Step S206 is performed again. The number of characteristic points for which the image recognition has succeeded is 2, so the processing in Steps S202 to S205 is further performed for a third characteristic point (for example, the characteristic point C3). Here, it is assumed that the space between the camera 21 or the camera 22 and the characteristic point C3 is occluded by a part of the vehicle body, and the image recognition for the characteristic point C3 has failed. In this case, the number of characteristic points for which the image recognition has succeeded remains 2, so the processing in Steps S202 to S205 is further performed for a fourth characteristic point (for example, characteristic point C4). Here, it is assumed that the image recognition for the characteristic point C4 has succeeded.

In following Step S206, it is determined that the number of characteristic points for which the recognition has succeeded is 3 or more. In this case, the positional parameter calculation means 34 calculates the positional parameters of the camera 21 or the camera 22 based on the two-dimensional coordinates of all the characteristic points for which the recognition by the image recognition unit 31 has succeeded (in this example, characteristic points C1, C2, and C4) (Step S208). This processing is performed in a manner similar to Step S113 of FIG. 8 in the first embodiment.

As described above, in the second embodiment, if the image recognition unit 31 has not recognized the two-dimensional coordinates of a predetermined number of characteristic points, the turn-ON request generation means 36 generates a new turn-ON request and the image recognition unit 31 performs image recognition for a new characteristic point. Therefore, even if the image recognition has failed for some of the characteristic points, an additional characteristic point or points are turned ON for image recognition so that the number of characteristic points is made enough for calculating the positional parameters of the camera.

Then, as in the first embodiment, the relative position identification means 35 identifies the relative positional relationship between the vehicle V and the parking space S, and the guide control unit 33 presents the guide information to the driver (not shown).

In the second embodiment described above, the number of the characteristic points used to calculate the positional parameters of the camera is 3 or more (Step S206), but the number may be different. That is, the number of the characteristic points to be used as references may be increased or decreased depending on calculation accuracy of the positional parameters of the camera or the number of positional parameters to be calculated.

Note that, although FIG. 5 shows only four characteristic points C1 to C4, but a fifth and subsequent characteristic points may be displayed at positions different from them. In that case, a plurality of characteristic points may have a partly overlapping positional relationship. In other words, the same illuminator 1 may belong to a plurality of characteristic points. Also in this case, only one characteristic point is turned ON at any one time, so it is not necessary to change the processing of the display control unit 11 and the image recognition unit 31.

In addition, in the second embodiment, even in a case where an image of only a part of the mark M can be taken, defining a sufficient number of characteristic points allows three or more characteristic points to be turned ON in a portion in which an image can be taken, so the positional parameters of the camera can be calculated. Therefore, it is not always necessary to install the mark M at a position where it is easy to see the entire mark M. For example, even in a situation in which the mark M is installed on a back wall surface of a parking lot and a part the mark M tends to be occluded by side walls of the parking lot, the positional parameters of the camera may be calculated appropriately.

Further, even in a situation in which the mark M has a large size and is not entirely contained in the field of view of the camera 21 or the camera 22, three or more characteristic points can be turned ON in the field of view so that the positional parameters of the camera are calculated appropriately.

### Third Embodiment

In the first and second embodiments, regardless of the distance between the mark M and the camera 21 or the camera 22, the characteristic points of the same size (for example, characteristic points C1 to C4 in FIG. 5) are always used for image recognition. In a third embodiment, a different number of characteristic points of different sizes are used depending on the distance between the mark M and the camera 21 or the camera 22.

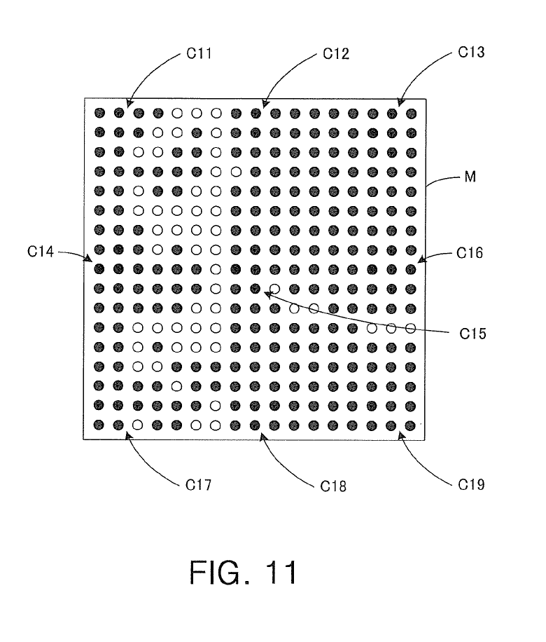

FIG. 11 illustrates a state in which the illuminators 1 of the mark M display characteristic points C11 to C19 used in the third embodiment. In the third embodiment, the characteristic points C1 to C4 shown in FIG. 5 and the characteristic points C11 to C19 shown in FIG. 11 are used selectively depending on the distance between the mark M and the camera 21 or the camera 22. The characteristic points C1 to C4 of FIG. 5 have a first size and the characteristic points C11 to C19 of FIG. 11 have a second size smaller than the first size. Note that, for example, the size of a characteristic point is defined by the number of illuminators 1 constituting the characteristic point.

In addition, the number (first number) of the characteristic points C1 to C4 of FIG. 5 is 4 and the number (second number) of the characteristic points C11 to C19 of FIG. 11 is 9, which is larger than the first number. Therefore, the number of the turn-ON requests (number of first turn-ON requests) for displaying the characteristic points C1 to C4 of FIG. 5 is 4 and the number of the turn-ON requests (number of second turn-ON requests) for displaying the characteristic points C11 to C19 of FIG. 11 is 9.

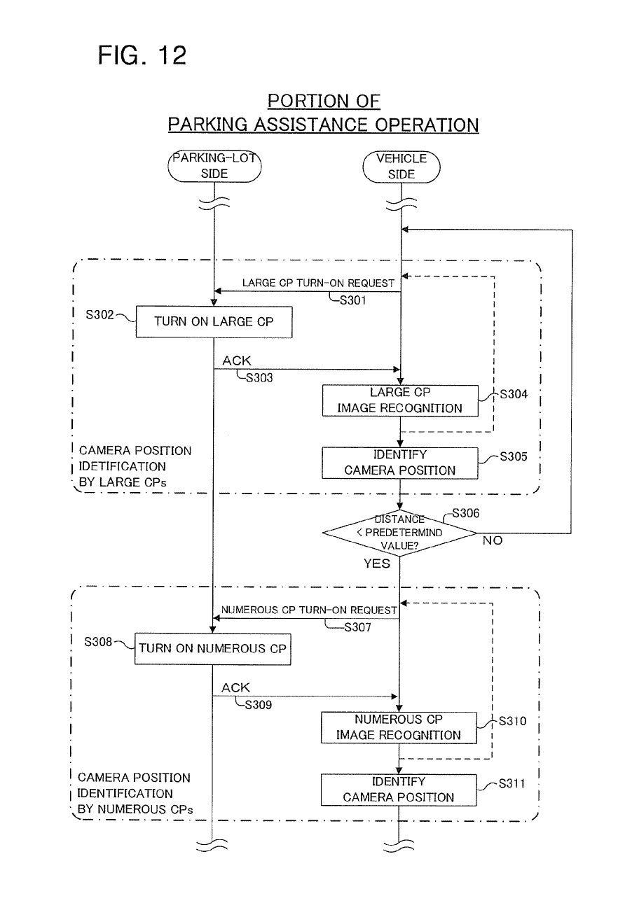

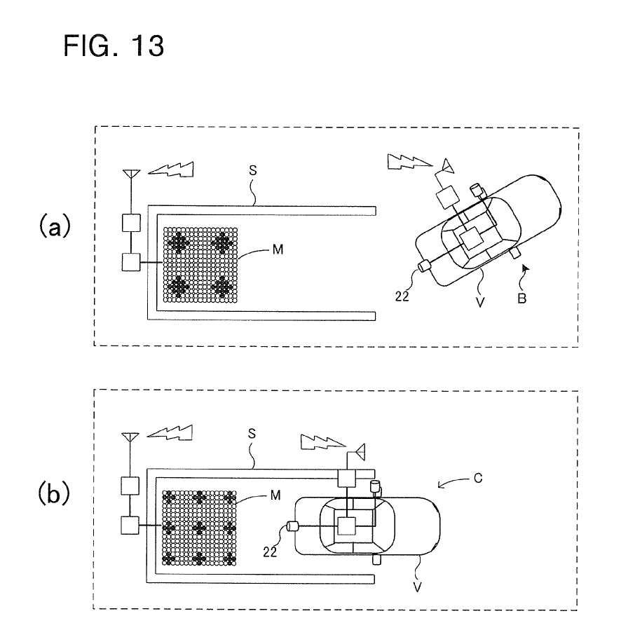

Next, referring to the flow chart of FIG. 12 and schematic diagrams of FIG. 13, an operation of a parking assistance apparatus in the third embodiment is described. FIG. 12 illustrates a part of the detailed operation included in Step S5 of FIG. 6, and FIG. 13 illustrates states of the mark M and positions of the vehicle V at respective time points.

At one time point in the parking assistance operation, the vehicle V and each of the parking space S and the mark M have a relative positional relationship as illustrated in FIG. 13(a). The vehicle V is at a location B, and the camera 22 can take an image of the entire mark M.

First, as illustrated in Steps S301 to S305 of FIG. 12, camera position identification processing is performed using large characteristic points. The large characteristic points are, for example, the characteristic points C1 to C4 of FIG. 5. Note that, Steps S301 to S304 of FIG. 12 are repeated the same number of times as the number of the characteristic points (in this case, 4) as in the first embodiment. In this manner, the image recognition unit 31 recognizes the two-dimensional coordinates of each of the characteristic points C1 to C4 of FIG. 5.

At this stage, the characteristic points C1 to C4 having the first size, which is relatively large, are used, so a clear image of each of the characteristic points can be taken even if the distance between the camera 22 and the mark M is large. Therefore, the image recognition can be performed at high accuracy.

Next, based on the two-dimensional coordinates of the characteristic points C1 to C4 recognized by the image recognition unit 31, the positional parameter calculation means 34 calculates the positional parameters consisting of six parameters of the three-dimensional coordinate (x, y, z), tilt angle (inclination angle), pan angle (direction angle), and swing angle (rotation angle) of the camera 21 with respect to the mark M (Step S305). This processing is performed in a manner similar to Step S113 of FIG. 8 in the first embodiment (note that eight relational expressions are used because the number of characteristic points is four).

In relation to this, as in the first embodiment, the relative position identification means 35 identifies the relative positional relationship between the vehicle V and the parking space S, and the guide control unit 33 presents the guide information to the driver (not shown).

Further, the positional parameter calculation means 34 calculates the distance between the camera 22 and the mark M based on the calculated positional parameters of the camera 22, and determines whether or not the distance is less than a predetermined threshold (Step S306). If it is determined that the distance is equal to or more than the predetermined threshold, the processing returns to Step S301, and the camera position identification processing using the large characteristic points is repeated.

Then, the driver drives the vehicle V in accordance with the guide information from the guide control unit 33 (for example, backward) so that the vehicle V and each of the parking space S and the mark M have the relative positional relationship as illustrated in FIG. 13(b). The vehicle V is at a location C, at which location the distance between the camera 22 and the mark M becomes less than the predetermined threshold.

If it is determined in Step S306 that the distance between the camera 22 and the mark M is less than the predetermined threshold, camera position identification processing is performed using numerous characteristic points as shown in Steps S307 to S311. The numerous characteristic points are, for example, the characteristic points C11 to C19 of FIG. 11. Note that, Steps S307 to S310 of FIG. 12 are repeated the same number of times as the number of the characteristic points (in this case, 9) as in the first embodiment. In this manner, the image recognition unit 31 recognizes the two-dimensional coordinates of each of the characteristic points C11 to C19 of FIG. 11.

At this stage, a relatively large number of characteristic points C11 to C19 are used, so a large number of (in this case, 18) relational expressions for calculating positional parameters can be obtained. Therefore, the accuracy of the positional parameters can be improved.

Although the characteristic points C11 to C19 have the second size which is relatively small, the camera 22 is now close to the mark M, so a clear image may be taken even for the small characteristic points. Therefore, the accuracy of image recognition can be maintained.

In the third embodiment described above, only two patterns of the characteristic points, that is, the pattern illustrated in FIG. 5 and the pattern illustrated in FIG. 11 are used, but three or more patterns may be used. Specifically, a large number of patterns may be used so that the characteristic points are gradually decreased in size and gradually increased in number, and are selectively used in response to the distance.

Further, although the positional parameters are used for determining the distance in the third embodiment, the relative positional relationship may be used instead. Specifically, the distance between the vehicle V and the parking space S may be determined based on the relative positional relationship between the vehicle V and the parking space S, and the determination in Step S306 may be performed based on the distance.

### Fourth Embodiment

In the first to third embodiments, only one mark M is used as the fixed target. In a fourth embodiment, a mark set including two marks is used as the fixed target.

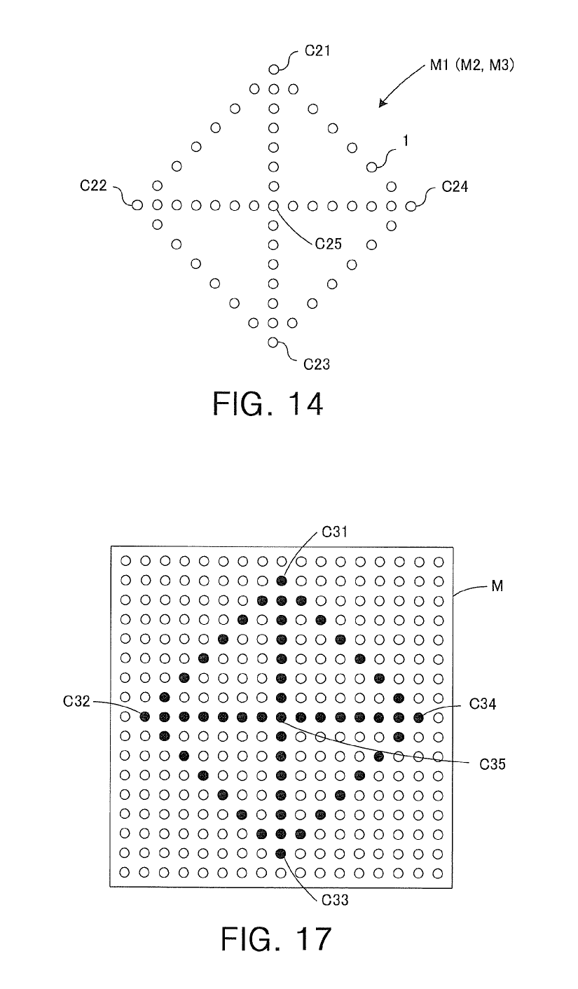

FIG. 14 illustrates a construction of a first mark M1 according to the fourth embodiment. A plurality of illuminators 1 are fixedly arranged along with a predetermined shape of the first mark M1. As opposed to the first to third embodiments, the first mark M1 according to the fourth embodiment displays predetermined characteristic points by turning ON all the illuminators 1 simultaneously. In FIG. 14, the illuminators 1 are arranged in a shape obtained by combining predetermined line segments. Five characteristic points C21 to C25 can be recognized by recognizing the line segments by image recognition and then determining intersections of the line segments.

A second mark M2 also has the same construction as that of the first mark M1 illustrated in FIG. 14.

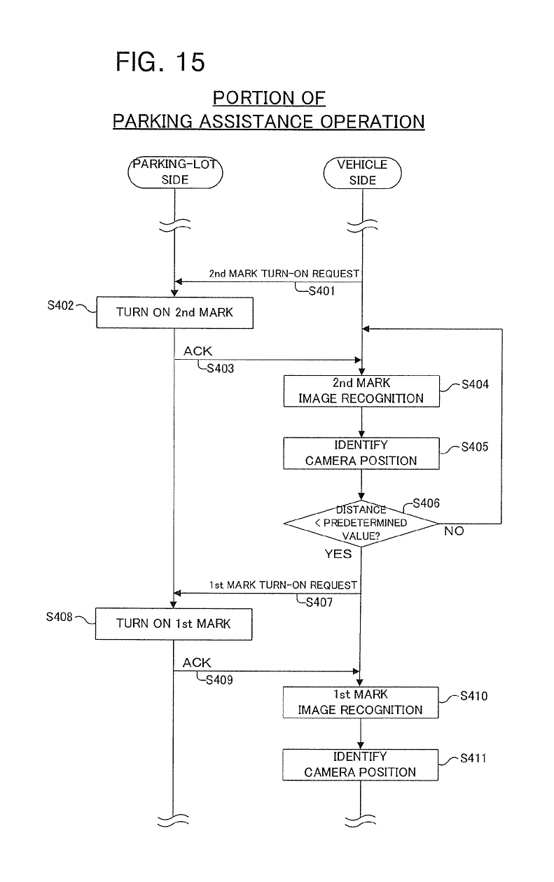

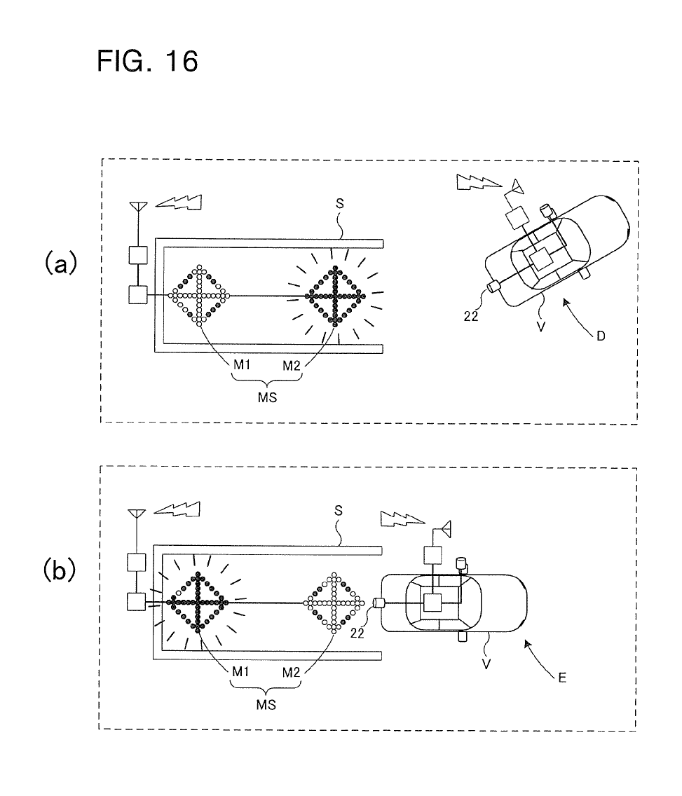

Next, referring to the flow chart of FIG. 15 and schematic diagrams of FIG. 16, an operation of a parking assistance apparatus in the fourth embodiment is described. FIG. 15 illustrates a part of the detailed operation included in Step S5 of FIG. 6, and FIG. 16 illustrates states of a mark set MS and positions of the vehicle V at respective time points. The mark set MS is a fixed target in the fourth embodiment and includes the first mark M1 and the second mark M2 as a plurality of fixed target portions.

At a certain time point in the parking assistance operation, the vehicle V and each of the parking space S and the mark set MS have the relative positional relationship as illustrated in FIG. 16(a). The vehicle V is at a location D, and the camera 22 can take an image of the entire second mark M2.

In the processing of FIG. 15, the turn-ON request generation means 36 first generates a turn-ON request, which is information indicating that the second mark M2 is to be turned ON, and transmits the generated turn-ON request to the parking-lot-side device 10 (Step S401). The turn-ON request indicates, for example, that only the second mark M2 is to be turned ON among the first mark and the second mark M2 included in the mark set MS. Alternatively, the turn-ON request may indicate that only the illuminators 1 constituting the second mark M2 are to be turned ON among all the illuminators 1 included in the mark set MS.

Next, the display control unit 11 turns ON the second mark M2 based on the turn-ON request for the second mark M2 (Step S402). Thereafter, the display control unit 11 transmits an acknowledgement as a turned-ON notification indicating that the second mark M2 is ON (Step S403). FIG. 16(a) is a schematic diagram at this time point.

If the parking assistance computing unit 32 receives the turned-ON notification indicating that the second mark M2 is ON, the image recognition unit 31 performs image recognition for the characteristic points C21 to C25 included in the second mark M2 (Step S404). In Step S404, the image recognition unit 31 receives an image taken by the camera 22 as an input, extracts the characteristic points C21 to C25 of the second mark M2 from the image, and recognizes and obtains the two-dimensional coordinates of the characteristic points C21 to C25 of the second mark M2 in the image. In other words, in the fourth embodiment, one turn-ON request corresponds to a plurality of characteristic points to be turned ON simultaneously. This is different from the first to third embodiments in which one turn-ON request corresponds to one characteristic point.

Although the first mark M1 and the second mark M2 have the same shape, the parking assistance computing unit 32 recognizes the two-dimensional coordinates as coordinates of characteristic points included in the image of the second mark M2 because the turn-ON request (Step S401) transmitted immediately before Step S404 or the acknowledgement (Step S403) received immediately before Step S404 is related to the second mark M2.

Next, based on the two-dimensional coordinates of each of the characteristic points C21 to C25 of the second mark M2 recognized by the image recognition unit 31, the positional parameter calculation means 34 calculates the positional parameters consisting of six parameters of the three-dimensional coordinate (x, y, z), tilt angle (inclination angle), pan angle (direction angle), swing angle (rotation angle) of the camera 21 with respect to the second mark M2 (Step S405). This processing is performed in a manner similar to Step S113 of FIG. 8 in the first embodiment (note that ten relational expressions are used because the number of characteristic points is five).

In relation to this, as in the first embodiment, the relative position identification means 35 identifies the relative positional relationship between the vehicle V and the parking space S, and the guide control unit 33 presents the guide information to the driver (not shown).

Further, the positional parameter calculation means 34 calculates the distance between the camera 22 and the second mark M2 based on the calculated positional parameters of the camera 22, and determines whether or not the distance is less than a predetermined threshold (Step S406). If it is determined that the distance is equal to or more than the predetermined threshold, the processing returns to Step S404, and the image recognition and the camera position identification processing are repeated in the state wherein the second mark M2 is ON.

Then, the driver drives the vehicle V in accordance with the guide information from the guide control unit 33 (for example, backward). As the vehicle travels backward, the camera 22 approaches the second mark M2 and the second mark M2 becomes larger in the image taken by the camera 22. Here, it is assumed that the vehicle V and each of the parking space S and the mark set MS now have the relative positional relationship illustrated in FIG. 16(b). The vehicle V is at a location E, at which location the distance between the camera 22 and the second mark M2 becomes less than the predetermined threshold.

If it is determined in Step S406 that the distance between the camera 22 and the second mark M2 is less than the predetermined threshold, the turn-ON request generation means 36 generates the turn-ON request for the first mark M1 and transmits the generated turn-ON request to the parking-lot-side device 10 (Step S407).

Next, similar processing as in Steps S401 to S405 is performed for the first mark M1.

Specifically, the display control unit 11 turns ON the first mark M1 and turns OFF the second mark M2 based on the turn-ON request for the first mark M1 (Step S408). FIG. 16(b) is a schematic diagram at this time point. Then, the display control unit 11 transmits an acknowledgement as a turned-ON notification indicating that the first mark M1 is ON (Step S409).

If the parking assistance computing unit 32 receives the turned-ON notification indicating that the first mark M1 is ON, the image recognition unit 31 performs image recognition for the characteristic points C21 to C25 included in the first mark M1 (Step S410). In Step S410, the image recognition unit 31 receives an image taken by the camera 22 as an input, extracts the characteristic points C21 to C25 of the first mark M1 from the image, and recognizes and obtains the two-dimensional coordinates of the characteristic points C21 to C25 of the first mark M1 in the image.

Next, based on the two-dimensional coordinates of the characteristic points C21 to C25 of the first mark M1 recognized by the image recognition unit 31, the positional parameter calculation means 34 calculates the positional parameters consisting of six parameters of the three-dimensional coordinate (x, y, z), tilt angle (inclination angle), pan angle (direction angle), and swing angle (rotation angle) of the camera 21 with respect to the first mark M1 (Step S411).

In relation to this, as in the first embodiment, the relative position identification means 35 identifies the relative positional relationship between the vehicle V and the parking space S, and the guide control unit 33 presents the guide information to the driver (not shown).

As described above, according to the fourth embodiment, the marks to be used for the image recognition are switched in response to the positional relationship between the camera and the mark set MS, in particular, the distance between the camera and each mark included in the mark set MS, so the likelihood of recognizing any one of the marks at any time is increased. For example, if the vehicle V and the parking space S are apart from each other, the second mark M2 closer to the vehicle V is turned ON so that the characteristic points may be recognized more clearly. On the other hand, as the vehicle V and the parking space S become closer to each other and the second mark M2 falls out of the field of view of the camera 22, the first mark M1 is turned ON so that the characteristic points may be recognized more reliably.

In the fourth embodiment described above, the mark set MS includes only the first mark M1 and the second mark M2. However, the mark set MS may include three or more marks, which are used selectively depending on the distance between the camera and each of the marks.

Further, although the positional parameters are used for determining the distance in the fourth embodiment, the relative positional relationship may be used instead. Specifically, the distance between the vehicle V and the parking space S may be determined based on the relative positional relationship between the vehicle V and the parking space S, and the determination in Step S406 may be performed based on the distance.

Further, the first mark M1 and the second mark M2 may be constituted by the mark M as in the first to third embodiments. FIG. 17 illustrates such construction. Among the illuminators 1 included in the marks M, only the illuminators 1 at positions corresponding to the illuminators 1 included in the first mark M1 and the second mark M2 illustrated in FIG. 14 are turned ON so that characteristic points C31 to C35 of the mark M may be recognized by processing similar to the characteristic points C21 to C25 of the first mark M1 and the second mark M2.

Further, the determination in Step S406 may be performed based on an amount different from the distance between the camera and the second mark M2. For example, the determination may be performed based on the number of the characteristic points successfully recognized among the characteristic points C21 to C25 of the second mark M2. In this case, switching to the first mark M1 is made at a time when the positional parameters can no longer be calculated by using the second mark M2, or at a time when the calculation accuracy becomes low.

In the fourth embodiment, all the characteristic points C21 to C25 in any one of the first mark M1 and the second mark M2 are simultaneously displayed, and an image recognition technique that distinguishes the characteristic points from each other is used. However, if the mark M according to the first to third embodiments is used instead of the first mark M1 and the second mark M2, it is possible to turn ON the characteristic points sequentially and recognize them independently as in the first to third embodiments so that a simpler image recognition technique can be used.

### Fifth Embodiment

The fourth embodiment contemplates parking assistance in a single direction with respect to the parking space S. A fifth embodiment relates to a case where, in the fourth embodiment, parking assistance is performed for parking in any of two opposite directions toward a single parking space.

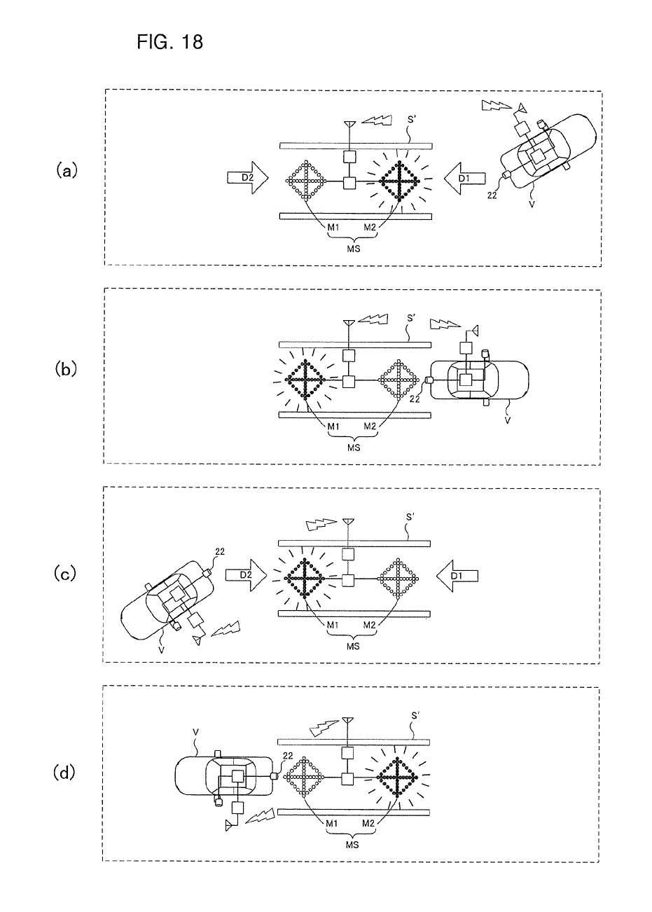

As illustrated in FIG. 18(a), a parking space S′ allows parking from either of opposite directions D1 and D2. That is, the vehicle V can be parked to face either of the directions D1 and D2 when parking is complete. In addition, the first mark M1 and the second mark M2 are arranged symmetrically, for example, in the parking space S′. In other words, if the parking space S′ is rotated 180 degrees, the first mark M1 and the second mark M2 replace each other.

First, as illustrated in FIG. 18(a), a case where the vehicle V is parked in the direction D1 will be considered. In this case, the second mark M2 is turned ON first. As the vehicle V travels, the distance between the camera used for image recognition of the characteristic points and the second mark M2 becomes smaller. If the distance falls below a predetermined threshold, the second mark M2 is turned OFF and the first mark M1 is turned ON. FIG. 18(b) illustrates this state. As in the fourth embodiment, the mark to be used for image recognition is switched depending on the distance between the camera and each of the marks included in the mark set MS, the likelihood that one of the marks can always be recognized is increased.

Conversely, if the vehicle V is parked in the direction D2, the first mark M1 is turned ON first. FIG. 18(c) illustrates this state. As the vehicle V travels, the distance between the camera used for image recognition of the characteristic points and the first mark M1 becomes smaller. If the distance falls below the predetermined threshold, the first mark M1 is turned OFF and the second mark M2 is turned ON. FIG. 18(d) illustrates this state. As in the fourth embodiment, the mark to be used for image recognition is switched depending on the distance between the camera and each of the marks included in the mark set MS, the likelihood that one of the marks can always be recognized is increased.

As described above, in the fifth embodiment, the order in which the first mark M1 and the second mark M2 included in the mark set MS are turned ON is determined in response to the parking direction of the vehicle V. Therefore, the effects similar to those of the fourth embodiment can be obtained regardless of the direction of the parking.

Note that, whether the parking is performed in the direction D1 or D2, that is, the order in which the first mark M1 and the second mark M2 are turned ON, may be specified by the driver by operating a switch or the like. Alternatively, image recognition may be performed at first for both the first mark M1 and the second mark M2, and the control unit 30 of the vehicle-side device 20 may determine the order in response to a result of the image recognition.

### Sixth Embodiment

A sixth embodiment relates to a case where, in the fifth embodiment, parking assistance using only a single mark M is performed.

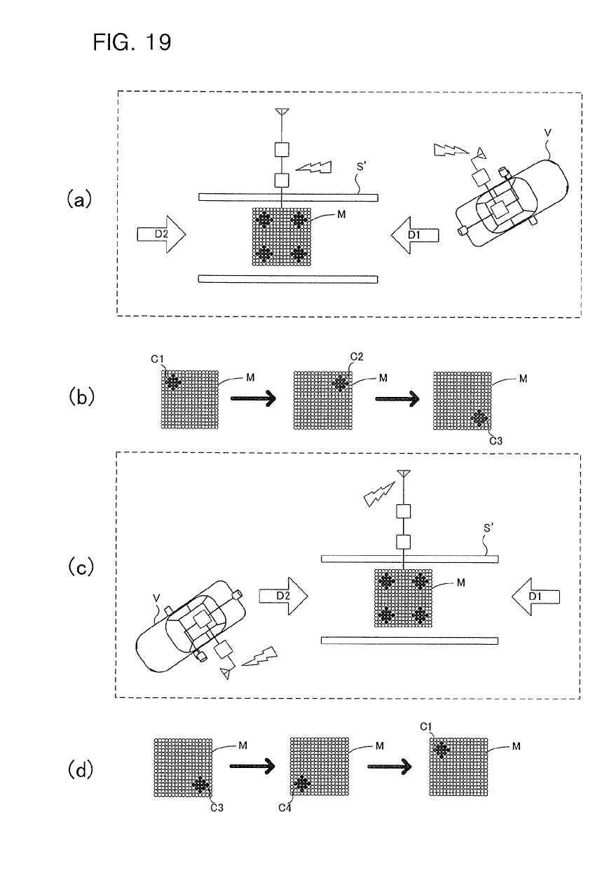

As illustrated in FIG. 19(a), the parking space S′ allows parking from either of the opposite directions D1 and D2. The mark M is located at the center of the parking space S′. First, let us consider a case where the vehicle V is parked in the direction D1. In this case, as illustrated in FIG. 19(b), for example, at first image recognition is performed for the characteristic point C1 as the first characteristic point, then image recognition is performed for the characteristic point C2 as the second characteristic point, and finally image recognition is performed for the characteristic point C3 as the third characteristic point.

Next, as illustrated in FIG. 19(c), a case where the vehicle V is parked in the direction D2 will be considered. In this case, as illustrated in FIG. 19(d), for example, at first image recognition is performed for the characteristic point C3 as the first characteristic point, then image recognition is performed for the characteristic point C4 as the second characteristic point, and finally image recognition is performed for the characteristic point C1 as the third characteristic point. In this case, the first to third characteristic points are different from those shown in FIG. 19(b) and they are turned ON at positions obtained by rotating the characteristic points illustrated in FIG. 19(b) by 180 degrees with respect to the mark M. Thus, the characteristic points are turned ON at positions depending on the direction in which the vehicle V is parked.

In this manner, upon calculating the positional parameters of the camera, the same road surface coordinates can always be used without need to change the road surface coordinates of the characteristic points depending on the parking direction. For example, the positional relationship of the first characteristic point with respect to the mark M is fixed, so the same values can always be used for Δxm1, Δym1, and Δzm1 in Simultaneous Equations 1 of the first embodiment. Therefore, simple calculation processing may be used for the positional parameters while providing parking assistance in both directions.

Although the sixth embodiment described above relates to a case where the parking assistance is performed for only two directions, parking assistance in a larger number of directions may be performed depending on the shape of the parking space. For example, in a case where the parking space is one that is substantially square in shape and allows parking from any of north, south, east, and west, the positions of the characteristic points may be rotated every 90 degrees depending on the parking direction.

1. A parking assistance apparatus for assisting parking at a predetermined target parking position, comprising:
a vehicle-side device mounted on a vehicle; and
a parking-lot-side device provided in association with the predetermined target parking position,
the parking-lot-side device comprising:
a fixed target comprising a plurality of light-emitting means, the fixed target being fixed in a predetermined positional relationship with respect to the predetermined target parking position, each of the plurality of light-emitting means being provided in a predetermined positional relationship with respect to the fixed target;
parking-lot-side communication means, which receives a turn-ON request transmitted from the vehicle-side device, the turn-ON request containing information regarding which of the plurality of light-emitting means is to be turned ON; and
display control means for turning ON or OFF the plurality of light-emitting means based on the turn-ON request,
the vehicle-side device comprising:
turn-ON request generation means for generating the turn-ON request;
vehicle-side communication means for transmitting the turn-ON request to the parking-lot-side device;
a camera for taking an image of at least one of the plurality of light-emitting means;
image recognition means for extracting characteristic points based on the image of the at least one of the plurality of light-emitting means taken by the camera and recognizing two-dimensional coordinates of the characteristic points in the taken image;
positional parameter calculation means for calculating positional parameters of the camera including at least a two-dimensional coordinate and a pan angle with respect to the fixed target, based on two or more two-dimensional coordinates recognized by the image recognition means and on the turn-ON request;
relative position identification means for identifying a relative positional relationship between the vehicle and the target parking position based on the positional parameters of the camera calculated by the positional parameter calculation means and the predetermined positional relationship of the fixed target with respect to the predetermined target parking position; and
parking locus calculation means for calculating a parking locus for guiding the vehicle to the target parking position based on the relative positional relationship identified by the relative position identification means.

2. A parking assistance apparatus according to claim 1, wherein the turn-ON request generation means sequentially generates a plurality of different turn-ON requests.

3. A parking assistance apparatus according to claim 1, wherein, if the image recognition means has not recognized the two-dimensional coordinates of a predetermined number of the characteristic points, the turn-ON request generation means generates a new turn-ON request.

4. A parking assistance apparatus according to claim 1, wherein:
the turn-ON request comprises a first turn-ON request for turning ON characteristic points of a first size and a second turn-ON request for turning ON characteristic points of a second size;
the second size is smaller than the first size, and a number of the characteristic points corresponding to the second turn-ON requests is larger than a number of the characteristic points corresponding to the first turn-ON requests; and
the turn-ON request generation means generates one of the first turn-ON request and the second turn-ON request depending on the positional parameters or on the relative positional relationship.

5. A parking assistance apparatus according to claim 1, wherein one turn-ON request corresponds to one characteristic point.

6. A parking assistance apparatus according to claim 1, wherein:
the fixed target comprises a plurality of fixed target portions;
each of the plurality of fixed target portions comprises a plurality of light-emitting means;
one turn-ON request corresponds to a plurality of the characteristic points to be turned ON simultaneously in any one of the plurality of fixed target portions; and
the turn-ON request generation means generates different turn-ON requests depending on the positional parameters or on the relative positional relationship.

7. A parking assistance apparatus according to claim 1, wherein:
the characteristic points are circular; and
the two-dimensional coordinates of the characteristic points are two-dimensional coordinates of centers of circles formed by respective characteristic points.

8. A parking assistance method using a vehicle-side device mounted on a vehicle and a parking-lot-side device provided in association with a predetermined target parking position, comprising the steps of:
transmitting a turn-ON request from the vehicle-side device to the parking-lot-side device;
turning ON or OFF a plurality of light-emitting means based on the turn-ON request;
taking an image of at least one of the light-emitting means;
extracting characteristic points of a fixed target based on the image taken of the light-emitting means and recognizing two-dimensional coordinates of the characteristic points in the taken image;
calculating positional parameters of a camera including at least a two-dimensional coordinate and a pan angle with respect to the fixed target, based on two or more recognized two-dimensional coordinates and on the turn-ON request;
identifying a relative positional relationship between the vehicle and the target parking position based on the calculated positional parameters of the camera and the predetermined positional relationship of the fixed target with respect to the target parking position; and
calculating a parking locus for guiding the vehicle to the target parking position based on the identified relative positional relationship.
